(19) United States
(12) Patent Application Publication
(10) Pub. No.: US 2004/0210175 A1
(43) Pub. Date: Oct. 21, 2004

(54) Blow-molded foot rest

(76) Inventors: Edward S. Robbins III, Muscle Shoals, AL (US); Ronald R. White, Florence, AL (US)

Correspondence Address: INDIANAPOLIS OFFICE 27879, BRINKS HOFER GILSON & LIONE, ONE INDIANA SQUARE, SUITE 1600, INDIANAPOLIS, IN, 46204-2033, US

(21) Appl. No.: 10/419,354

(22) Filed: Apr. 21, 2003

(51) Int. Cl. A61H 7/00

(52) U.S. Cl. 601/134; 601/136

(57) ABSTRACT

A foot rest is formed by a thick-walled, preferably blow molded, container for containing a thermally therapeutic liquid with an upper surface configured to facilitate the massage of the feet. The container foot rest includes a neck portion having a mouth to fill the container and a closure. The container also has a shoulder portion expanding outward from the neck portion that can support a handle. A body portion of the container has a lower generally planar side forming a base of the foot rest. An upper side can be domed or curved in a cylindrical arc, and includes an array of outward projections. The lower surface includes a substrate gripping feature for gripping a carpet or floor. The foot rest can be used in either a sitting or standing position and is inexpensive to manufacture.

### BACKGROUND

1. Technical Field

The present invention is directed to foot rests and particularly to kinesitheraputic foot rests that facilitate the massaging of the soles of feet by contact with a plurality of protuberances.

2. Background Information

A variety of foot massaging devices are known in which a plurality of upstanding protuberances are formed on a surface of a more or less resilient body for stimulation of the soles of the feet by standing or rubbing contact with the protuberances. For example, mats of various configuration are disclosed in U.S. Pat. Nos. D348,108; 2,476,921; 3,100,483; 3,885,555; 6,293,916; 6,478,756; and 6,506,173 that are typically intended for use while in a standing position. Some foot massaging devices are specifically intended for use in a sitting position such as are disclosed in U.S. Pat. Nos. D339,638; D351,027; D443,064; 5,056,507 and 6,013,042. Other foot massaging devices involve moving parts such as rollers as in U.S. Pat. Nos. D360,696; D396,111; 5,674,185 and 6,409,690. The known massaging devices have also included the application of heat energy as disclosed, for example, in U.S. Pat. No. 4,429,687.

There remains a need for a foot massaging device that is inexpensive, can be used in a standing or sitting position, and can simultaneously apply either heat or cold to the sole of the foot.

### BRIEF SUMMARY

Accordingly, a foot rest of the present invention has the form of a thick-walled container for containing a thermally therapeutic liquid, which can be either hot or cold, with an upper surface configured to facilitate the massage of the feet. The container forming the foot rest generally includes a neck portion having a mouth to permit the filling of the container with a liquid of suitable temperature and a closure for closing the mouth. The container also has a shoulder portion integrally formed with and expanding outward from the neck portion to an outer margin that can be rectangular in shape. A handle can be attached to or molded integrally with the neck or shoulder of the container to facilitate handling of the foot rest. A body portion having two sides is integrally formed with and extends longitudinally from the outer margin of the shoulder portion to an end margin. An end portion is integrally formed with and closes the end margin of the body portion. A first side of the body portion is substantially planar and forms a base of the foot rest. A second side is situated opposite the first side can be domed or curved in a cylindrical arc, and includes an array of outward projections that are configured to facilitate the massage of the feet. With the first surface in contact with a floor, the second side is elevated from the floor by a distance that is preferably suitable to elevate the feet while in a sitting position, yet is not so dangerously high as to prevent use of the foot rest in a standing position.

A foot rest of the present invention can be formed in an extrusion blow-molding process using any suitable blow-moldable polymer such as, for example, polyethylene terephthalate, polyvinylchloride, high density polyethylene, or polypropylene, whether virgin, regrind or recycled, at low cost. The container portions are sufficiently thick to inhibit any significant deformation of the container as a result of pressure applied during a foot massage. The wall thickness of the container should be sufficient to withstand the pressures likely to be applied by one standing on the container. The wall thickness should also be sufficient to withstand any shock likely to be experienced from dropping a foot rest from a height of three foot or more while filled with a liquid such as iced or hot water. It will be appreciated that the iced or hot water in the container forming the foot rest can be used to combine massage with a suitable thermal treatment.

The side of the container forming the base of the foot rest can have a substrate gripping feature. The substrate gripping feature can be, for example, a surface configured to interact with pile of carpeting, or a tack surface designed to interact with a smooth floor. For example, one surface configuration that can interact with pile of carpeting is a hook loop fastener such as Velcro® that can be adhered to the first side of the container forming the foot rest. One or more strips or rings of a soft rubber can be used to interact with a smooth floor to retain the foot rest at a desired location.

Other features and advantages of the present invention will become apparent to those of ordinary skill in the art from a consideration of the following description and the accompanying drawings.

### BRIEF DESCRIPTION OF THE DRAWINGS

FIG. 1 is a perspective view of a blow-molded foot rest of the present invention.

FIG. 2 is a sectional view taken along line 2-2 of the blow-molded foot rest in FIG. 1.

FIG. 3 is a bottom plan view of an alternate embodiment.

### DETAILED DESCRIPTION OF PREFERRED EMBODIMENTS

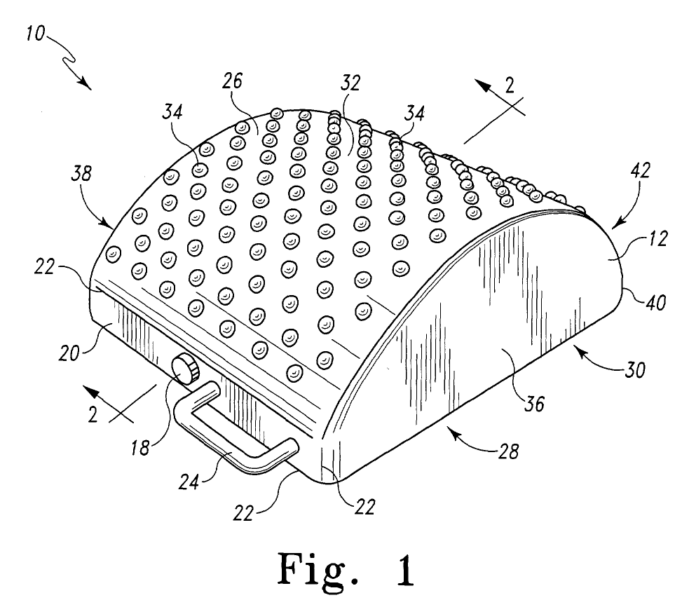

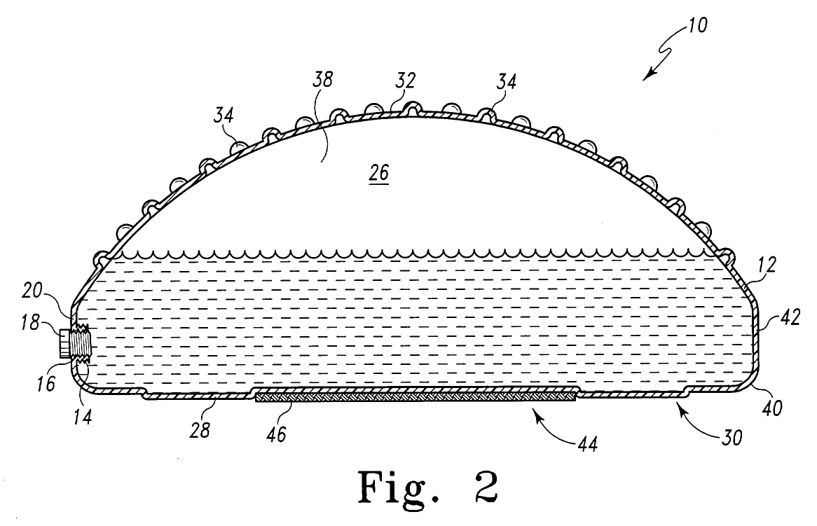

A foot rest 10 of the present invention is shown in FIG. 1 to include a thick-walled container 12 for containing a thermally therapeutic liquid 14, shown in FIG. 2. The liquid 14 can be either hot or cold and can fill what ever proportion of the container 12 is desired by the user. The liquid L can be transferred into and out of the container 12 through a mouth 16 within a neck portion 14. A closure 18 can be used to seal the container 12 so that the liquid L is retained within the container 12. The container 12 forming the foot rest 10 also has a shoulder portion 20 that extends outwardly from the neck to an outer margin 22 that is shown to be generally rectangular in shape. A handle 24 is fixed to the shoulder portion 20 to facilitate handling of the foot rest 10. A body portion 26 of the container 12 joins the outer margin 22 of the shoulder portion 20. The body portion 26 includes a first lower side 28, which is substantially planar and forms a base 30 for the foot rest 10. A second upper side 32 of the body portion 26 is situated opposite the first side 28. The upper side 32 is shown to be formed in a curved cylindrical arc but can be domed or curved to imitate the natural arch of the bottom of the feet. The upper side 32 an array of outward projections 34 that are configured to facilitate massage of the feet. The upper side 32 and the lower side 28 are joined to each other by lateral sides 36 and 38. The sides 28, 32, 36 and 38 of the body portion 26 are integrally formed with and extend longitudinally from the outer margin 22 of the shoulder portion 20 to an end margin 40. A generally planar end portion 42 is integrally formed with and closes the end margin 40 of the container 12.

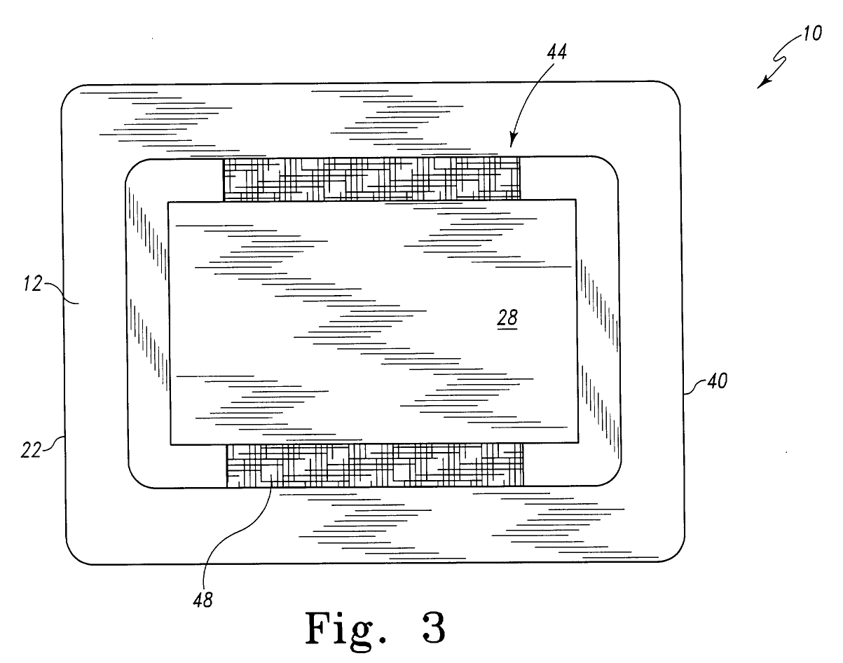

The lower side 28 of the container 12 forming the base 30 of the foot rest 10 can have a substrate gripping feature 44 as shown in FIGS. 2 and 3. The substrate gripping feature 44 can be, for example, a surface 46 configured to interact with pile of carpeting as shown in FIG. 2, or a tack surface 48 designed to interact with a smooth floor as shown in FIG. 3. The carpet interacting surface 46 can be formed by a hook loop fastener such as Velcro® that can be adhered to the first side 28 of the container 12 forming the foot rest 10. The tack surface 48 can be formed by one or more strips or rings of a soft rubber or other modestly tenacious material that will interact with, but not permanently bond to, a smooth floor to retain the foot rest at a desired location despite small lateral forces being applied to the foot rest 10. With the first surface 28 in contact with a floor or other supporting surface, the lateral sides 36 and 38 should elevate the second side 32 by a distance that is preferably suitable to elevate the feet while in a sitting position, yet is not so dangerously high as to prevent use of the foot rest 10 while in a standing position. A typical vertical dimension for the lateral sides 36 and 38 is between about 10 cm and 12 cm.

A foot rest 10 of the present invention can be formed by a variety of manufacturing processes. A particularly suitable process is an extrusion blow-molding process that uses any suitable blow-moldable polymer such as, for example, polyethylene terephthalate, polyvinylchloride, high density polyethylene, or polypropylene, whether virgin, regrind or recycled. The manufacturing variables of this process, and the large variety of plastic resins that can be satisfactorily used in the process are well known. The process is capable of manufacturing foot rests 10 of the present invention at low cost and high reliability. The container wall portions 20, 28, 32, 36, 38, and 42 should be sufficiently thick to inhibit any significant deformation of the container 12 as a result of pressure applied during a foot massage. The wall thickness of the container should also be sufficient to withstand the pressures likely to be applied by someone standing on the container. It will be recognized that with the container 12 full of a liquid L, any pressure applied at any point on the container 12 will be hydraulically transferred to form a substantially uniform interior pressure within the container 12 including on the closure 18. It is important that the junction between the neck 16 and closure 18 be able to withstand the expected hydraulic pressures. The wall thickness and the junction between the neck 16 and the closure 18 should also be sufficient to withstand any shock likely to be experienced from dropping a foot rest 10 from a height of three foot or more while filled with a liquid L, whether that liquid is iced or hot water or another fluid. It will be appreciated that there will be some differences in the performance behavior of most polymers forming the container 12 when filled with iced water as compared to hot water.

It is therefore intended that the foregoing detailed description be regarded as illustrative rather than limiting, and that it be understood that it is the following claims, including all equivalents, that are intended to define the spirit and scope of this invention.

1. A foot rest in the form of a thick-walled container for containing a thermally therapeutic liquid comprising:
a neck portion having a mouth, a closure for closing the mouth, a shoulder portion integrally formed with and expanding outward from the neck portion to an outer margin, a body portion integrally formed with and extending longitudinally from the outer margin of the shoulder portion to an end margin, and an end portion integrally formed with and closing the end margin of the body portion, the body portion including a first side that is substantially planar, and a second side opposite the first side, the second side including an array of outward projections, the shoulder portion, body portion and end portion being sufficiently thick to inhibit significant deformation of the container.

2. The foot rest of claim 1 wherein the body portion has a wall thickness of at least about 0.5 mm.

3. The foot rest of claim 1 wherein the projections of the array extend outward from the second side by at least about 2 mm.

4. The foot rest of claim 1 wherein the projections of the array extend outward from the second side by a distance of about 1 to 4 times the wall thickness of the body portion.

5. The foot rest of claim 1 further comprising a carpet gripping segment fixed to the first side of the body portion.

6. The foot rest of claim 5 wherein the carpet gripping segment comprises a pad of hook loop engaging material fixed to a central portion of the first side.

7. The foot rest of claim 5 wherein the carpet gripping segment comprises a plurality of strips of hook loop engaging material fixed adjacent a perimeter of the first side.

8. The foot rest of claim 1 further comprising a handle fixed to the container.

9. The foot rest of claim 8 wherein the handle is integrally formed with and protrudes from the shoulder portion of the container.

10. The foot rest of claim 1 wherein the second side is formed as a cylindrical arc.
